(19) United States
(12) Patent Application Publication
(10) Pub. No.: US 2003/0110095 A1
(43) Pub. Date: Jun. 12, 2003

(54) Method and system of purchasing shoes

(76) Inventor: Noam Danenberg, Herzelia (IL)

Correspondence Address: Kevin D. McCarthy, Roach Brown McCarthy & Gruber, P.C., 1620 Liberty Building, 420 Main Street, Buffalo, NY, 14202, US

(21) Appl. No.: 10/340,462

(22) Filed: Jan. 9, 2003

Related U.S. Application Data
(63) Continuation-in-part of application No. PCT/IL01/00639, filed on Jul. 12, 2001.

(30) Foreign Application Priority Data
Jul. 13, 2000 (GB) 0017254.4
Feb. 21, 2001 (IL) 141573

(51) Int. Cl. G06F 17/60

(52) U.S. Cl. 705/26

(57) ABSTRACT

The present invention concerns a method, device and system for the interactive sale of customized shoes, wherein the individual's foot parameters are obtained by a pedometer to prepare a customized sole and the shoe is selected utilizing a computer network within a retail store.

### FIELD OF THE INVENTION

The present invention relates to a method and system for the purchase of shoes.

### BACKGROUND OF THE INVENTION

Purchasing of goods that accommodate various customers' sizes, such as clothes and shoes is many times a process fraught with frustrations for the potential purchaser. Many times only after deciding on the desired style, shape and color of the clothes/shoe, the customer discovers, to his/her annoyance, that his/her particular size is not available in the specific store. Many times customers make several choices, for example, of a specific shoe style, only to discover again and again that their particular size is missing, and many times this causes the customer to terminate the purchasing process altogether.

Managing the inventory of retail outlets of such goods as shoes and clothes is also fraught with difficulties. All inventory within retail outlets is usually prepaid for and there is no possibility to exchange or send it back to the manufacturer and thus, at the end of the season, retail outlets often have bulk left-over inventory that cannot be sold.

Although existing manufactured designs take into consideration some statistical data concerning potential customers' sizes, this data is not always reliable and is quite crude. While the general distribution of sizes (such as shoe sizes) in the population can be determined, it is difficult a priori to, estimate which style of shoes, or clothing is most likely to be purchased by customers with a particular shoe or clothes size. This impedes mass customized production of these goods.

The advance of e-commerce has not completely eliminated the above difficulties. Shoppers at an e-mail site are presented with various styles of shoes and clothing for selection, some of which is not actually available in their particular size. Only after the complicated process of selecting and ordering has been terminated, is the customer informed that the selected goods cannot be provided because his particular size is unavailable.

The retail shoe industry suffers from two overheads that substantially cut its profits: the size of the store and the amount of sales personnel required to execute a sale. Shoe stores have to maintain a bulk-occupying inventory, which requires renting or purchasing a large space solely for the purpose of stocking shoes. In addition, the process of selling a pair of shoes is work-intensive since typically the customer cannot by himself retrieve the shoes of the desired size and style, so that each customer has to be assisted by a sales person.

Sales transactions of various goods through the Internet are rapidly increasing in percentage, and it is predicted that within the next couple of years, a substantial percentage of all retail commerce will be conducted in electronic form. A provider of goods sold through the Internet benefits from a substantial reduction in overhead costs and of the need to locate stores in expensive areas. While some goods are already purchased in large quantities through the net (such as software and books) other goods have not been successful at penetrating into e-commerce due to various logistical reasons as well as a consumer psychologically against e-mail purchases. Many people prefer purchasing goods only if they can physically feel or try the goods. Shoes fall into this category. Typically, a potential customer is reluctant to order by the Internet a pair of shoes from a website, since the importance of the fit and comfort of the shoe requires that the shoe be physically tried before purchase.

Electronic pedometers are electronic devices that utilize a barosensitive pressure plate that measures foot pressure distribution either during standing, or during movement (walking, running or jumping). The electronic output of the pedometer can be converted to digital data for various purposes including physical training, correction of posture and for use as data for the production of orthopedic insoles.

### SUMMARY OF THE INVENTION

The method of the invention provides for a two-step process, in which the first step provides for the selection of a shoe by the customer, and the second step provides for the selection of the insole. The invention permits to generate a close match for the customer's foot by matching the insole that is appropriate for both the shoe and the foot.

Accordingly, the invention permit a customer to purchase a shoe he wants, even if the shoe available in stock is not a close match for his foot, and to turn it into a match for his foot by selecting an appropriate insole. In other words, in the process of the invention the insole acts as an interface between a desirable shoe and the customer's foot. This method substantially differs from prior art methods difference, since according to prior art methods the customer has to select a shoe that closely fits his foot, and then the insole is simply fitted to the shoe. As will be appreciated, the invention permits a much greater flexibility in the selection of a shoe from an available stock, and therefore it provides substantial advantages for both the merchant and the customer. This is also due to the fact that it is much simpler and more economic to provide a large stock of insoles that can be used to match otherwise non-perfectly matching shoes to a foot of a customer, than to maintain a large stock of shoes of various dimensions, types and sizes.

Accordingly, in one aspect, the invention relates to a shoe selling apparatus and store comprising:

(a) an electronic pedometer and/or a digital camera and image analysis system for determining size parameters of an individual and for obtaining a digital data representation of said parameters;

(b) a user interface permitting an individual to select a shoe type and to initiate a shoe purchasing sequence of said shoe, said interface also permitting the individual to input his particulars;

(c) software to select, on the basis of the details of the selected shoe and of said digital data representation of said parameters, an insole that matches both the customer's foot and the selected shoe, thereby to generate a close matching shoe for the analyzed foot; and

(d) a communication module for transmitting at least data relating to the selected shoe and the individuals particulars to a system server for subsequent dispatch to the individual of the purchased shoe.

According to a preferred embodiment of the invention the shoe selling apparatus further comprises a module for (i) receiving the digital data representation of the size parameters; (ii) comparing said data representation to a database containing a plurality of data items each of which relates to a foot type for which an insole is available. to identify the one with the closest match to said data representation; and (iii) identifying the insole corresponding to said closest match.

According to another preferred embodiment of the invention the shoe selling apparatus further comprises an insole vending unit for providing the identified insole corresponding to said closest match.

The communication module, in one embodiment of the invention, also transmits data relating to the identified insole corresponding to said closest match. In another embodiment the communication module also transmits the digital data representation of said size parameters.

In another aspect the invention relates to a system for purchasing shoes comprising:

(a) one or more shoe selling apparatuses according to any one of claims 1 to 5;

(b) a system server for receiving particulars relating to purchasing individual and data relating to a selected shoe and for initiating a sequence of supply of purchasing shoes to the purchasing individual.

In a further aspect the invention encompasses a method for purchasing shoes comprising:

(a) determining the size parameters of the foot of an individual by an electronic pedometer and/or digital camera and image analysis software;

(b) obtaining digital data representation of said parameters;

(c) selecting a desired and matched shoe type and transmitting data representative of the selection of said selected shoe type and the particulars of the purchasing individual to a system server;

(d) selecting, on the basis of the details of the selected shoe and of said digital data representation of said parameters, an insole that matches both the customer's foot and the selected shoe, thereby to generate a close matching shoe for the analyzed foot; and

(e) dispatching to the individual the selected shoe.

According to a preferred embodiment of the invention the insole matching said foot parameters is provided by a method comprising (i) receiving the digital data representation of the foot parameters; (ii) comparing said data representation to a database containing a plurality of data items each of which relates to a foot type for which an insole is available, to identify an insole being a closest match to said data representation; and (ii) identifying the insole corresponding to said closest match.

In a preferred embodiment of the method of the invention the information of the identified insole is used to provide the individual with an insole at the shoe-selling apparatus site.

According to another preferred embodiment of the method of the invention the information of the identified insole is communicated to the system server, and the insole is dispatched to the individual together with the purchased shoe.

According to another preferred embodiment of the method of the invention the insole is provided as an integral part of the shoe.

Although reference is made herein particularly to the sales of shoes, and this is the primary object of the invention, it should be understood that the invention can also be applied to other goods, e.g., clothes.

By one aspect termed “the selective display” aspect, the present invention is based on the realization that when a customer selects a garment or shoes for purchase from an electronic catalog such as a local network or a website, it is preferable that only those garments or shoes which fit the customers' specific size and dimensions be displayed. This selective display saves the customer the frustrating experience of first choosing an article of clothing or shoes, only to discover that his/her particular size is not in stock.

Thus, the present invention concerns a clothes/shoes display apparatus comprising:

(a) an input module for entering size parameters of a potential customer;

(b) a communication module for transmitting said size parameters to a system server holding data of all available clothes/shoes present in a specific inventory;

(c) display means for displaying to the customer only available clothes/shoes suitable to the customer's specific size parameters.

In one embodiment of the present invention, the display apparatus is suitable for the display of shoes.

The term “input module” concerns any device or system which enables entry of data to the server. By one embodiment the input module is a user interface, for example a keyboard, a touch screen, etc. where the potential customer simply enters his/her shoe size, clothes size, etc., based on his personal knowledge or previously performed tests.

In one embodiment, the input module is an electronic pedometer, and optionally additional hardware comprising a digital camera and image analysis software. The input module determines shoe parameters of an individual, produces a digital data representation of said parameters and automatically transfers this data to the systems server. A more detailed explanation of the electronic pedometer will be given hereinbelow.

The term “user interface” in accordance with the invention, may be a computer, a cellular telephone, a telephone and the like which enables the individual to transmit data to a system server or surf in a website store. By one embodiment the user interface is a touch screen of a computer with pictures of all available shoe or cloths styles, which serve also as a catalogue as will be explained below. Preferably only those styles fitting the customer's particular size are displayed as explained in the “selective display” aspect of the invention.

The term “communication module” refers to software, or a software-hardware combination, which enables transmission of data from a user interface to a system server. Typically, the communication model is a telephone network (line, telephone or cellular telephone network), an optical fiber network, a point-to-point communication media such as the Internet, etc., together with suitable software for allowing transmitting of information from a user interface to a system server. Typical software is a browser used in the Internet.

The term “system server” refers to an addressable site in a computer network, for example, a specific site in the Internet. The computer network may be a local network, for example a local network of the retail store, or chain such as an Intranet. The server may be a stand alone terminal that receives data from a plurality of interfaces, processes the data and transfers the data to a communication network such as the Internet.

The term “electronic pedometer” refers to any apparatus which can measure foot parameters (see below) of a foot, for example by using barosensitive pressure plates and transforming the parameters to a digital data representation. The above term refers both to the electronic or digital apparatus itself as well as to the software associated therewith which enables said transformation.

The term “size parameters” in connection with feet refers to parameters of the shape of a foot which in fact reflects the topology of the foot. These parameters include the length and width of the foot, the dimensional picture and coordinates of the foot, as well as foot pressure distribution. In connection with clothing, this term refers to the width and length of the body and possibly also to the body shape.

Once the size parameters are entered either manually by the customer (through the user interface), or transmitted directly by electronic means such as the output of the pedometer, digital camera or image analysis software, the size parameters are communicated through a communication module to a system server.

The system server which, as indicated above, may be part of an Internet, or intranet, holds an updated database concerning the available inventory of the specific retailer, store, manufacturer, etc. This means that it comprises a database concerning all available styles, colors, and sizes of each product. Once the size parameters are entered (either by the user interface or automatically by the electronic pedometer), a matching sequence is performed, so that those types and colors of the goods suitable to the particular size parameters entered are displayed on the display means, with shapes, sizes, colors and types not currently available in the inventory either not being displayed or marked as “out of stock”. In one embodiment the available goods (shoes or clothing articles) are displayed in accordance with a “list of recommendations”. This means that where the available shoes comprise a list of more than one item, the first shoe on the list would be the best fit as regards foot parameters, including foot width, shape of shoe, shape of sole, topology etc., as for individual parameters there may be different recommendations

The display means are typically a computer screen.

This means that a potential customer sees, in accordance with the invention, only the shoes or clothes which can actually be purchased immediately since they are currently available in the specific inventory. Furthermore, the system “recommends” those shoes and clothes which are most suitable for the specific parameters of the customer as they are placed high on the list of recommendations.

The apparatus may be a shoe/clothes booth (kiosk) present in a large retail shoe store, which expedites the purchase sequence of a customer as it shows him/her only goods which are actually available in the store.

By another option, the apparatus may be a personal home computer, wherein the interface is simply a keyboard with which the customer types in his/her size parameters (for example, as known to them or as determined by a previous test with an electronic pedometer), the communication module is a point-to-point communication medium such as the Internet, and the server is the addressable site in the web from where goods may be ordered. A personal home computer user that logs onto a shop where the customer has previously made a test for determining his/her specific size parameters, views a shoe catalog showing the same shoes that are available to a customer at the store. The recommendation list would be based on the foot test previously taken and stored in the store database.

The invention is also advantageous for the store. The store keeps relevant information relating to its customers such as personal particulars, feet shape, preferred choices and their purchasing history. The store may use such data for internal analysis, for example, for determining future purchases or personalized stock liquidations by notifying potentially relevant customers of new shoes, dealers, etc. In addition, if a customer has a specific pattern of purchases it is possible to notify him of new goods that have become available consistent with his purchasing pattern.

The present invention in accordance with the “selective display aspect” concerns a shoe-selling apparatus comprising:

(a) an input module for entering size parameters of a potential customer;

(b) communication module for transmitting said size parameters to a system server holding data on all available shoes of all sizes present in a specific inventory;

(c) display means for displaying to the customer only available shoes of the customer's particular size;

(d) a user interface permitting the customer to select a shoe type and to initiate a shoe purchasing sequence of said shoe, said interface also permitting the individual to input his particulars; and

(e) communication module for transmitting at least data relating to the selected shoe and the individual's particulars to a system server for subsequent dispatch to the individual of the purchased shoe.

The communication module of (ii) and (v) may be the same or different. The user interface of (iv) may be the same user interface as used in the input module defined in (i) or may be different.

The term “purchasing sequence” refers to a sequence of activities carried out by an individual leading to a purchase of shoes or garments. These activities include at a minimum a test of the foot or body to produce the size parameters, the choice of a desired category relating to the type of shoes or garments (for example sport, casual, outdoor, elegant, etc.), transmittal of said choice to the server system (the website) through said communication module together with particulars sufficient for provision of the merchandise to the individual at a later date, such as the name and address of the individual. The purchasing sequence may also include a verification of the choice, as well as a sequence of activities for payment, such as input of an account number, the number of a credit or a debit card, verification of the number, etc.

The term “dispatch to the individual of the purchased shoe” refers to physically providing the individual with the merchandise for example by sending it through the mail, or by sending through a delivery service.

The present invention further concerns a system for purchasing shoes comprising:

(a) one or more selling apparatus as described above;

(b) a system server holding data relating to all available shoes or garments in a specific inventory;

(c) a system server for receiving particulars relating to a customer and for receiving data relating to a selected shoe or garment and for initiating a sequence of supply of purchased shoes or garments to the customer.

Both servers may be the same or may be different

The above system allows customers first to view, by utilizing a suitable display means, only shoes or garments of shapes, styles and sizes that are available in a specific inventory (such as an inventory of a retail store) and suitable to the customer's preferences, and later to purchase the shoes or garments.

Typically, the system server is a computer network addressable site, such as intranet present in a chain of stores or in a large department store.

The addressable site may also be present as a website in the Internet, so that customers may approach this system at home. The website would include information regarding all styles, sizes, colors, material and prices of shoes or garments that are available in accordance with the particular size of the potential customer, as entered by the input module. It may include in addition prices of the shoes or garments, menus for choosing the desired shoes or garments, modes for inserting the individual's particulars such as name, address, as well as optionally modes for obtaining payment from the individual such as software for obtaining information concerning credit or debit cards.

The present invention also concerns a method for purchasing shoes or garments comprising:

(a) entering by an input module size parameters of a customer;

(b) displaying to the customer only those styles and colors which match the size parameters;

(c) selecting a desired shoe or garment and transmitting data indicative of said selected shoe or garment and of particulars of the customer to a system server; and

(d) dispatching to the individual the selected shoe or garment.

As indicated the information can be used for the benefit of the owner of the store, for example, in using customer relationship management (CRM). Thus the invention concerns a method for customer relationship management (CRM) comprising:

(a) obtaining a database of individual parameters and associated size parameters by utilizing an electronic pedometer and/or a digital camera and image analysis system;

(b) processing said database to perform at least one of the following:

(One) personalized stock clearance involving informing individuals about available merchandise or sales appropriate to their size, particulars of previous purchases;

(Two) inventory forecast purchases.

In accordance with another aspect of the invention termed ‘“the electronic pedometer” aspect, the present invention is based on the realization that it is possible to purchase customized shoes by means of the Internet, or any other means without first trying them on, by choosing the desired shoe style and size, transmitting the choice to a website of the provider. The correct fit of the untried shoe is achieved by producing customized shoe insoles according to data representing the foot parameters of the individual, where the data is produced by a pedometer.

Thus, by one aspect the present invention provides a shoe-selling apparatus comprising:

(a) an electronic pedometer for determining size parameters of an individual and for obtaining a digital data representation of said parameters;

(b) a user interface permitting an individual to select a shoe type and to initiate a shoe purchasing sequence of said shoe, and to initiate a purchasing sequence of an insole to match the size parameters, said interface also permitting the individual to input his particulars; and

(c) a communication module for transmitting at least data relating to the selected shoe and the individuals particulars to a system server for subsequent dispatch to the individual of the purchased shoe.

The terms “electronic pedometer”, “user interface”, “communication module” are as described above. The term “purchasing sequence” is as described above and further comprises the purchase of the customized insole (for example by payment for it) although the insole may be provided separately as will be explained herein below. The purchase sequence includes the purchase of both the shoe and of the insole. By one business model, if the customer proceeds with the purchase of the shoe after he/she has obtained an insole, then the cost of the insole is refunded. This encourages the customer to proceed with the purchase sequence.

By one embodiment of the invention, an insole appropriate to the digital data presentation of the parameters is provided by the shoe booth containing the shoe selling apparatus itself, i.e. immediately after measurement of the shoe by an electronic pedometer, the insole is provided to the customer. The customer takes the insole, and awaits the dispatch of the selected shoe either immediately or at a later date. The insole can then be inserted into the shoe by the customer.

By another embodiment of the invention, the digital data representation of the parameters of the individual is transmitted through the communication module, to the system server for provision of an insole, and the insole is provided together with the shoe, either as two separate identities, or alternatively as a shoe having an integral insole.

In accordance with one embodiment of the invention, the data representation of the size parameters of a specific individual can be compared with a data representation in a database containing a plurality of data items each of which relates to a specific foot type. The size parameters of most individuals can be attributed to a specific foot type. A specific insole is attributed to each specific foot type, typically resulting in a total of about several tens to several hundred different insoles for example, where 8 foot models are used per foot per size, a total of 704 foot types and corresponding insoles are generated and these insoles can represent most of the feet in a population.

In accordance with the invention, the shoe selling apparatus also comprises a module for (i) receiving the digital data representation of the size parameters, for (ii) comparing said data representation to a database containing a plurality of data items each of which relates to a foot type for which an insole is available, to identify the one with the closest match to said data representation and (iii) for identifying the insole corresponding to said closest match. (Optionally the module can provide an individual analysis at the point of sale or on the server concerning the customer's specific size parameters, for example, as a computer print out or a digital picture). The information may be classified under a unique ID number for an individual which will enable the customer to transmit this ID to the system server, to use the ID to purchase an additional pair of shoes without measuring again the foot parameters and to receive the data (pictures, explanations) concerning his/her individual parameters

Once the identified insole corresponding to the closest match is identified, an insole suitable for the specific size parameters may be provided. Where the insole is provided in the shoe selling apparatus itself, the insole may be provided manually by a sales person present in a shoe booth containing the shoe-selling apparatus. The sales person, according to information concerning the identification of the insole, may physically reach into an inventory of insoles to supply the customer with the insole appropriate to his/her size parameters.

By another alternative, the shoe selling apparatus also comprises an insole vending machine, which upon receipt of information regarding the identified insole corresponding to the closest match, can automatically provide the desired insole immediately to the customer.

By yet another alternative, the information concerning the identified insole corresponding to the closest match may be transmitted by the communication module to the system server, and then, together with the purchased shoe the appropriate insole is also dispatched to the individual, either separately, or as an integral part of the shoe. It should be noted that the module for receiving the digital representation of the foot and associating it to an appropriate insole, may be present in the system server and not as part of the shoe selling apparatus. In that case the digital representation of the size parameters is transmitted to the server as “raw data”.

A selected shoe type is chosen in accordance with a “shoe catalogue” which may be present in one of the following manners:

(a) By one possibility, the shoes are physically displayed in the shoe booth as in any conventional shoe store, with each shoe having a specific catalogue number. The customer then transmits to the server's system the catalogue number of the shoe of choice.

(b) By another alternative, the shoe station contains a book or catalogue (on paper) or posters with all types of shoes available, each shoe having a specific catalogue number, to be transmitted to the system server.

(c) By yet another alternative, the user through the communication module, obtains information from the server system (for example from the website) concerning all relevant styles, colors and materials of shoes available. For example, where the server system is a website, the customer can browse through all possible models and colors of the shoes available, and then choose directly in the website, utilizing the user communication system, the shoes of his/her choice.

(d) A slight modification of the above is by use of a touch screen comprising a plurality of pictures of various shoe models, each picture electronically connected through said communication module to the system server, said touch screen being also the user interface.

Options (iii) and (iv) above are especially preferable as this also allows implementation of the first aspect of the invention, i.e. to display only those colors and shapes of shoes which are suitable to the specific size parameters.

The present invention further concerns a system for purchasing shoes comprising:

(a) one or more shoe selling apparatuses of the electronic pedometer aspect of the invention;

(b) a system server for receiving particulars relating to the purchasing individual and for receiving data relating to a selected shoe and for initiating a sequence of supply of purchasing shoes to a purchasing individual.

The above system enables the consumers to purchase shoe, which are customized, or would later on be customized, over the Internet.

Typically, the system server is a computer network addressable site, such as a website. The website may include information regarding all styles, sizes and colors and materials of shoes which are available (either directly on the website, or through connection to other websites), prices for each pair of shoes, menus for choosing the desired shoe, modes for inserting the individual's particulars, such as the name and address so that the dispatched shoe can be provided to the individual. By a preferred embodiment, the site also contains means for obtaining payment by the individual such as software for obtaining information concerning credit or debit cards or any other mode of payment, verifying said information and ensuring the transaction of payment means.

Optionally, the site may also contain information of all possible locations of shoe selling apparatus, so as to enable various users, not necessarily those communicating the site through the shoe selling apparatus, to know where shoes can be purchased by the apparatus of the invention.

The present invention also concerns a method for purchasing shoes comprising:

(a) determining the size parameters of an individual by an electronic pedometer and/or digital camera with image analysis software;

(b) obtaining digital data representation of said parameters;

(c) providing an insole matching said foot parameters;

(d) selecting a desired shoe type and transmitting said selected shoe type and the particulars of the purchasing individual to a system server; and

(e) dispatching to the individual the selected shoe.

As indicated above, the provision of the insole (iii) may be done immediately upon measurement of the foot parameters, at the site of a shoe booth containing the apparatus of the invention, or the provision of the insole may be carried out at a later date wherein the insole is dispatched together with the shoe.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic representation of the apparatus in accordance with the “electronic pedometer” aspect of the invention;

FIG. 2 is a schematic representation of the system in accordance with the “electronic pedometer” aspect of the invention;

FIG. 3 is a schematic representation of a shoe purchasing sequence in accordance with one preferred embodiment of the electronic pedometer aspect;

FIG. 4 shows a schematic representation of a system of the invention in accordance with the selective display aspect of the invention;

FIG. 5 shows the topology of soles which are obtained by an electronic pedometer;

FIG. 6 shows an example of a “recommendation list” obtained by the selective display aspect of the invention.;

FIG. 7 shows a screen for the store administration covering customer's purchase history; and

FIG. 8 shows a schematic representation of shoe selection in accordance with the “selective display” aspect.

### DETAILED DESCRIPTION OF AN EMBODIMENT OF THE INVENTION

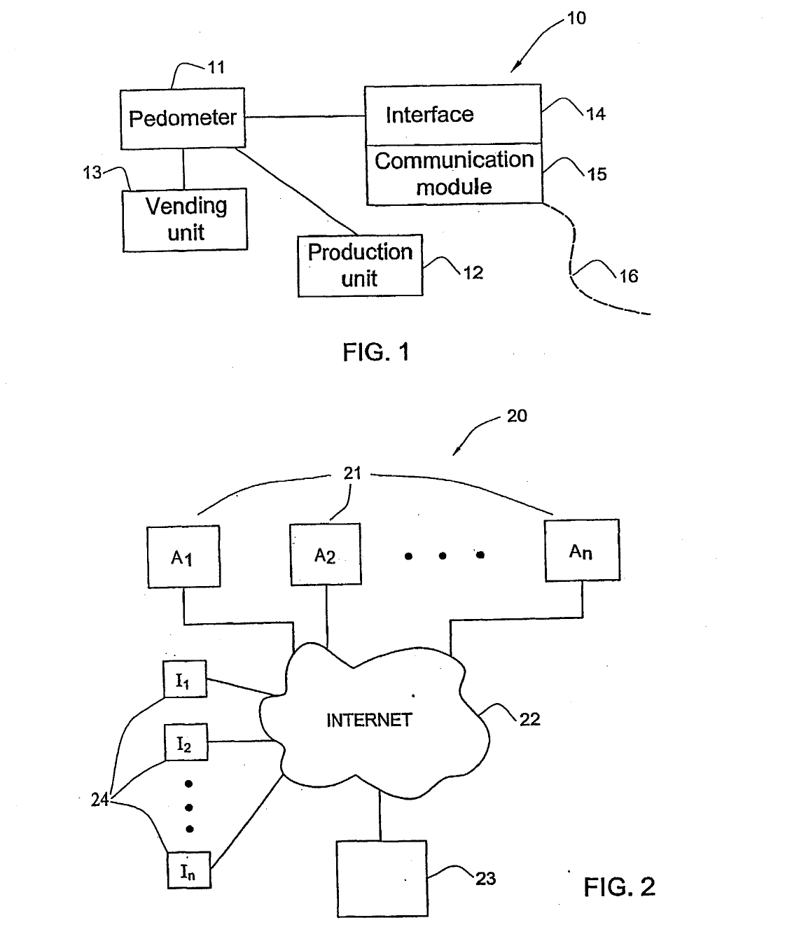

Reference is made to FIG. 1 which shows the shoe selling apparatus 10 of the invention. The apparatus may be present inside a sort of “shoe booth” or “shoe kiosk” which will look like a stand (with various advertisement signs) having inside a shoe pedometer, and an interface such as a computer. The shoe booth may be completely interactive (with no sales personnel), but by one embodiment may also have a sales personnel for carrying out any one of the above activities: helping the customer measure his foot by the pedometer, obtaining payment from the customer (if payment obtained is not part of the server system) and in cases where the insole is provided either immediately upon purchase, (and not at a later date together with the purchased shoe), sales personnel may also help physically obtain the insole. The apparatus comprises a pedometer 11 such as a machine comprising a pressurable plate that measures the foot pressure distribution. Typically, the pedometer contains a large number such as 1024 barosensitive sensors, measures the shape, pressure distribution, gait line, walking patterns, weight distribution, of the individual shoe. An example of such pedometer is Twin Pel manufactured in France, Novell manufactured in Germany

The electronic information of the foot parameters of the individual is converted by a software module associated with the pedometer into a digital data representation. The information from the pedometer may be converted by a module, such as specific software which compares the data representation with a plurality of data items relating to specific foot types, and associating a specific identified insole with the foot type to which foot parameters of the individual belongs. The identified insole may be provided to the customer in one of the following manners:

By one option it is manually provided by a sales personnel from an inventory of insoles to the customer immediately upon purchase, (not shown in the figure).

By another embodiment, the insole is provided through a vending unit 13 which is in essence a machine which has an opening for dispatching therethrough the insole of the correct size and shape, shown in accordance with the above module.

It should be understood that the pedometer may comprise the vending unit (for automatically providing the insole). Where the vending unit is not provided, the insole is either provided manually by the sales personnel, or is provided together with the dispatched shoe.

The apparatus also comprises an interface 14 such as a keyboard and screen of a computer. The customer can choose a shoe from a shoe catalogue (for example a physical book present in the shoe booth, an online catalog situated in a local computer network or on the web, a poster with all possible shoe types, a physical representation of possible shoes, etc.) and the choice is input via the keyboard thus utilizing a communication module 15 (for example a software known as a browser used for browsing a website), through communication line 16 (being for example a telephone line) to the system server (not shown in FIG. 1) and/or to the shoe manufacturer.

FIG. 2 shows the system of the invention 20. The system comprises a plurality of apparatuses of the invention 21, each corresponding to the apparatus 10 of FIG. 1 denoted A₁ . . . Aₙ. Each individual apparatus is connected through the Internet or Intranet 22 to the system server 23 that is a specific website (in the Internet, or being an Intranet), or a stand alone terminal receiving data from a plurality of apparatuses, screening the data and then transmitting it automatically to the Internet server. Beyond individuals who communicate to the server system through interface present in apparatus A₁ . . . Aₙ, other individuals denoted as I₁ . . . Iₙ (24) can communicate, through the Internet utilizing their own private interfaces (for example their computer) to the website 23. These individuals obtain from the website information regarding the shoe selling apparatus, and shoe selling method of the invention, as well as advertisements of various shoe types and information regarding the physical location of said selling apparatus, and shoe selling booths. Individuals I₁ . . . Iₙ may order shoes over the web using an ID code obtained during previous measurements utilizing the pedometers so that they may be customers purchasing shoes for a second or further time. The ID may also be stored by the system server so once an individual wishes to purchase a shoe a second or further time, input of his/her particulars will immediately his foot parameters so all that is needed is choice of the shoe model.

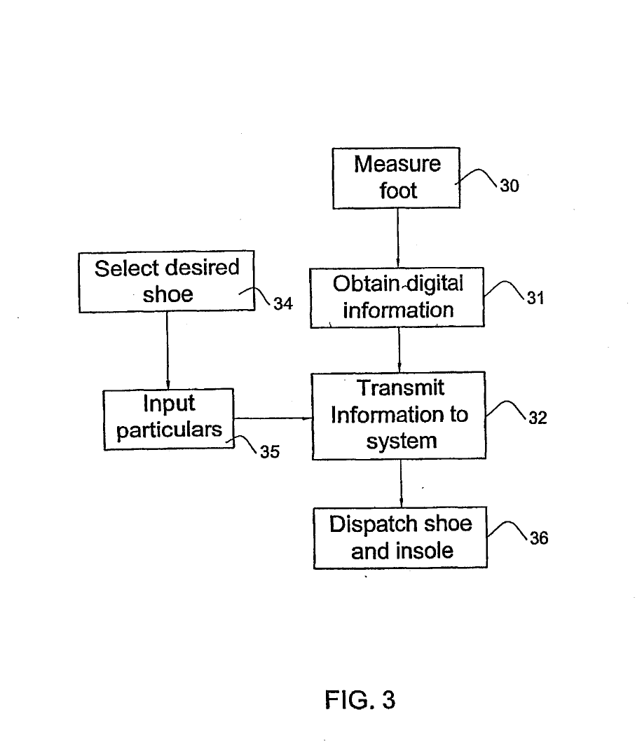

Reference is made to FIG. 3 which shows one embodiment of a method of purchasing shoes in accordance with the electronic pedometer invention. The method begins by measuring the foot by an electronic pedometer (step 30) and then obtaining a digital representation of the measured foot (step 31). The obtained digital representation is then transmitted to the server in step 32. At the server, the digital representation is compared with a database which contains a plurality of parameters each one relating to a specific foot type to which an insole is associated, to identify the appropriate insole to the specific parameters. By this, it is possible to associate an insole, appropriate to said foot type to the closest match.

Steps 30, 31 and 32 results in provision of an insole. After said sequence, before said sequence or simultaneously therewith, comes a step 34 of selecting a shoe, of a desired shoe type, color and material, for example by using the interface board to transmit a catalogue number of a desired shoe, according to information present in a large advertising board present in the booth both which contains the shoe apparatus. The selection may be by putting the catalogue number of the desired shoe through the interface, and transmitting said catalogue number through the Internet to the server. In addition, the individual parameters (such as name and mailing address) should be inputted to the server (step 35) so that the shoe may be provided to the individual.

The provider of the shoe receives the information from the server system (the website 23) regarding both the digital representation for providing the insole, and the selected desired shoe, and then dispatches a shoe with the appropriate insole in step 36, to the individual according to the parameters.

If desired, an additional step may be inserted between steps 35 and 32—a step of payment—i.e. sending information regarding credit or debit card from the user to the server and verifying said sent information (not shown in FIG. 3).

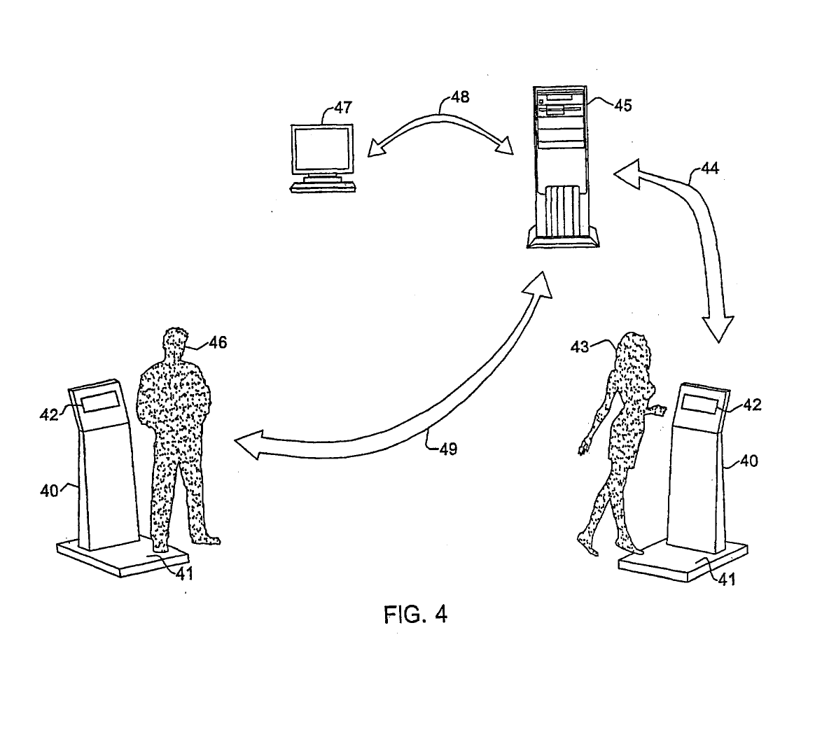

Reference is made to FIG. 4 which shows a schematic representation of the system of the invention in accordance with the “selective display” aspect of the invention.

The system is composed of one or more individual selective display apparatus of the invention 40. The apparatus is composed for example of an electronic pedometer 41 which comprises, for example, a large number of barsensitive sensors which measure the shape, pressure, distribution gate line, walking patterns, weight distribution of the individual. Each apparatus 40 also comprises a display screen 42 which in the present example is also a user interface touch screen. For example, an individual 43 measures her foot parameters on the electronic pedometer 41. Then, using the touch screen 42, she chooses which type of shoes (for example elegant shoes, sports wear etc.) she wishes to purchase.

Her choice of category, as well as the size parameters as measured by the electronic pedometer 41, are transferred via communication lines 44 to the system server 45, which holds a constantly updated database on all available shoes of all sizes present in the store's inventory. The server processes the information, and transfers back, through communication lines 44, to display screen 42 only those shoes which match the customer's 43 parameters, which are currently present in the store's inventory, together with additional information of their price, colors etc.

Another option relates to a customer 46 who has previously performed a measuring sequence on pedometer 41, the results of which were input into the server 45 and at the same time he received an identification I.D. Later on, the customer 46 enters his I.D. at a home computer 47 that is transferred through a communication line 48 to server 45, and then he sees on his home computer screen only those shoes that are available in the store's inventory which are suitable for him based upon the results of the previously performed pedometer measurements.

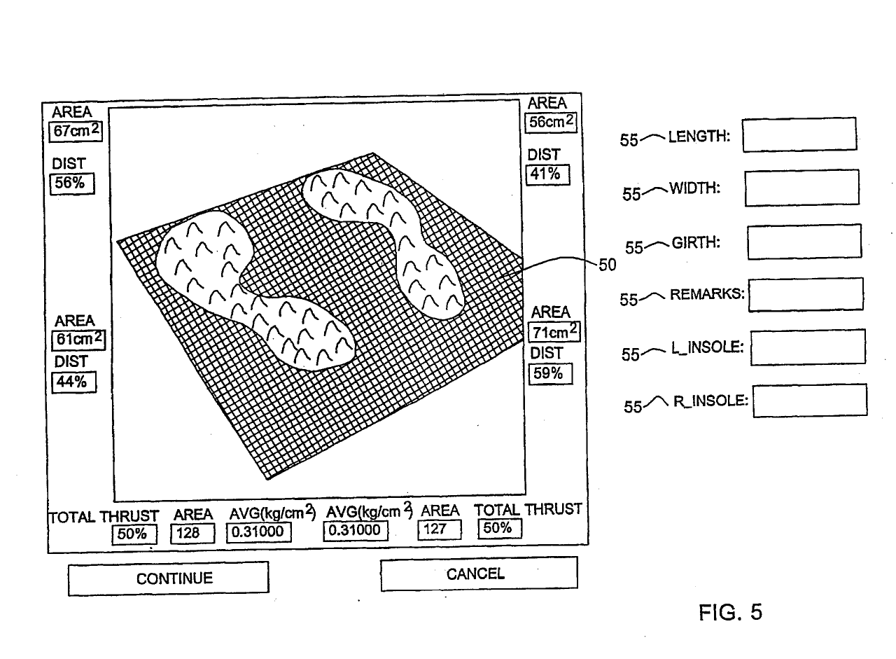

FIG. 5 shows an output of the electronic pedometer 41 which is transferred to the system server for determination of the best fit shoes. As can be seen the output includes representation of a three dimensional topology of the customer's foot 50, together with various parameters 55 derived from the pedometer measurement (length, width, girth, etc.)

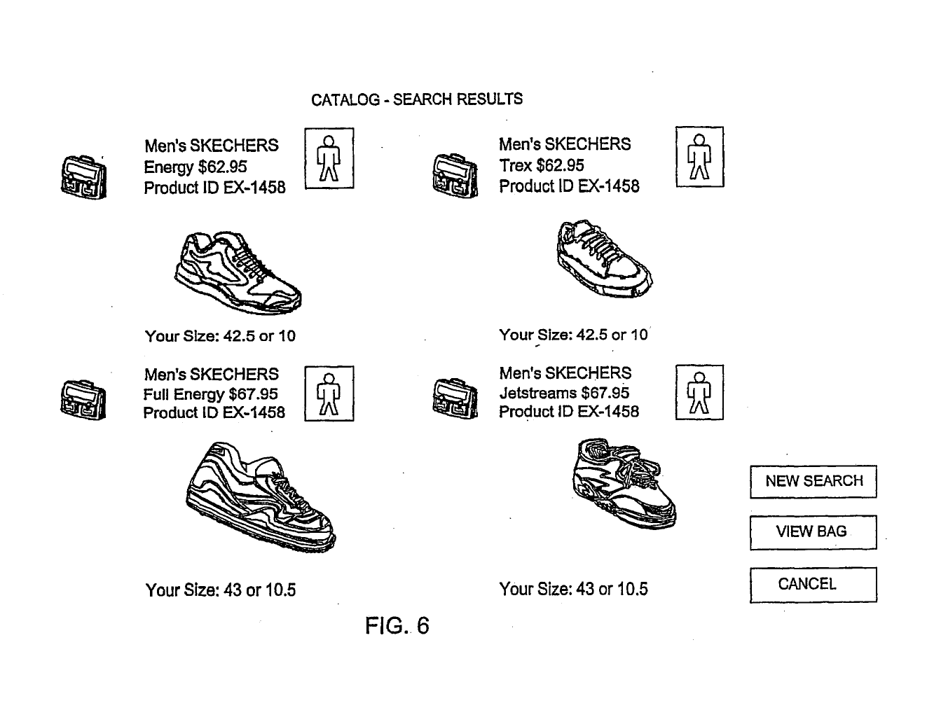

FIG. 6 shows a list of shoes recommended for a specific customer, for example, as displayed to the customer either on the screen 42 or the screen of computer 47 in FIG. 4. The customer has entered his size and foot parameters by utilizing an electronic pedometer 41 (as shown in FIG. 4). Then, the customer chooses a category of shoes, in the example of FIG. 6, the category of sport shoes was selected. Then, the screen selectively displays to the customer only those sport shoes, which fit his/her specific size parameters, in accordance with a recommendation list order, i.e. the first shoe (left hand upper corner) is the best fit shoe to the specific customer, etc. As can be seen, although the same customer is referred to, shoes produced by different companies may have different sizes for the same foot—indicating that buying by size alone may not be sufficient. The customer can then proceed with purchasing the desired shoes.

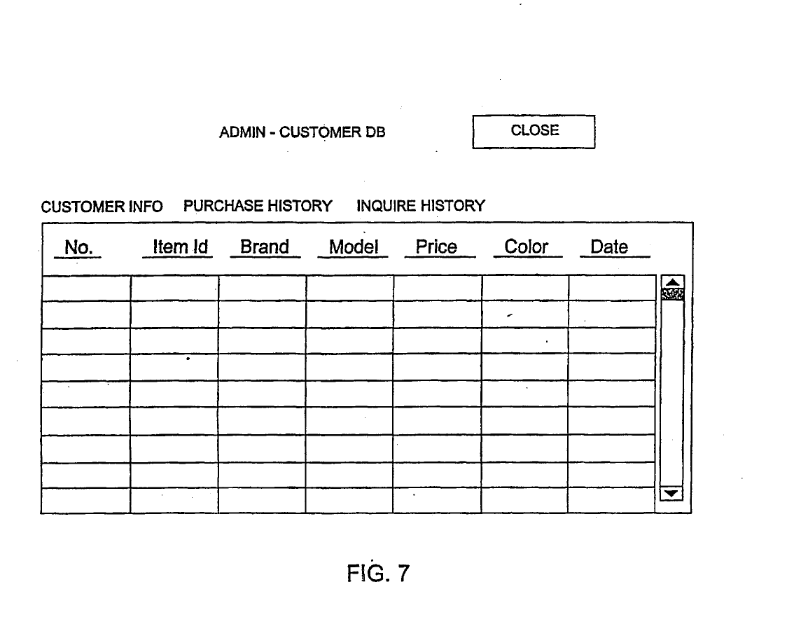

FIG. 7 shows a screen for the owner of the store, which contains information enabling him to manage the customer relationship, such as the customer information number (No.), and his purchase history including brand, model, price range, colors and date of previous purchases. This enables the owner of the store to offer customer specific shoes which are available in the inventory suitable to his/her particular past preferences, as well as to order shoes in the future in accordance with the distribution of customer preferences.

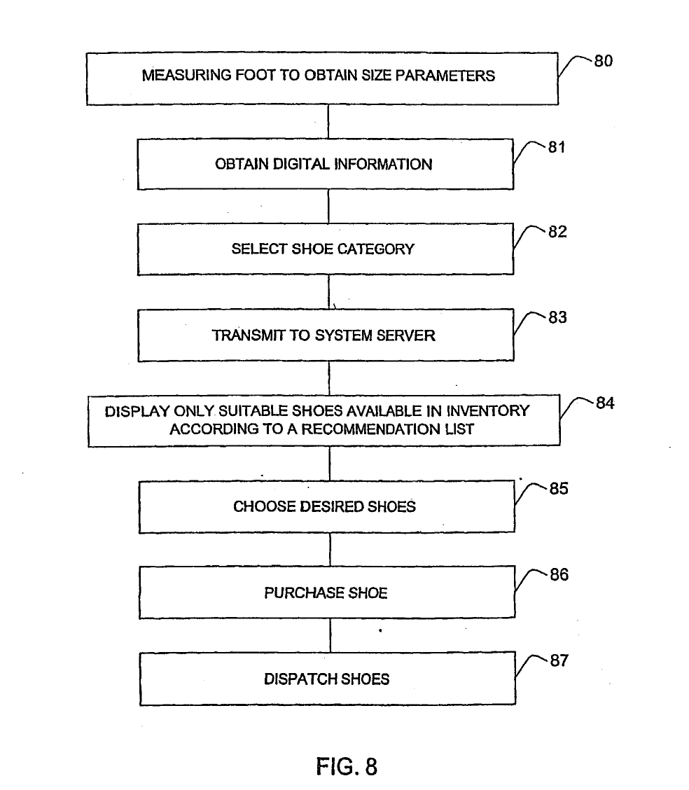

Reference is made to FIG. 8 which shows one embodiment of the method of purchasing shoes in accordance with the selective aspect mode of the invention. The method begins by measuring the foot 80 by an electronic pedometer (step 80) and then obtaining a digital representation of the measured foot (step 81), as explained with reference to FIG. 3. Then the customer selects the desired shoe category, (step 82) for example, from among: sportswear, outdoor, elegant, casual, etc. The two items of information (the digital representation refers and the selected category), are transmitted to the store's server in step 83, which stores in a memory a list of all shoes currently available in the inventory. If steps 82 and 84 are conducted through a personal computer, the customer transfers his previously measured foot parameters obtained in step 80 by inserting her personal I.D. This database of inventory is updated on-line, so if new shoes arrive, or if shoes are sold out, the database is immediately updated. At the server, the digital representation of the foot parameters, together with the category choice, are used to compare to the database of available inventory to give a best match. Then, in step 84, on the display of the apparatus, for example, on a screen, are displayed only those shoes which are appropriate for the customer's size parameters, arranged in hierarchy of a recommendation list.

Then, a customer can choose the desired shoe (step 85) and if the customer is present in the store he can physically go and purchase the shoe from a salesperson (step 86). Alternatively, if the purchase (step 86) is conducted through a personal computer, the customer selects the desired shoe and arranges payment, for example, by providing a credit card number. In this case the shoe is dispatched to the customer (step 87), for example, through the mail.

1. A shoe selling apparatus and store comprising:
(a) an electronic pedometer and/or a digital camera and image analysis system for determining size parameters of an individual and for obtaining a digital data representation of said parameters;
(b) a user interface permitting an individual to select a shoe type and to initiate a shoe purchasing sequence of said shoe, said interface also permitting the individual to input his particulars;
(c) software to select, on the basis of the details of the selected shoe and of said digital data representation of said parameters, an insole that matches both the customer's foot and the selected shoe, thereby to generate a close matching shoe for the analyzed foot; and
(d) a communication module for transmitting at least data relating to the selected shoe and the individuals particulars to a system server for subsequent dispatch to the individual of the purchased shoe.

2. A shoe selling apparatus according to claim 1 further comprising a module for (i) receiving the digital data representation of the size parameters; (ii) comparing said data representation to a database containing a plurality of data items each of which relates to a foot type for which an insole is available. to identify the one with the closest match to said data representation; and (iii) identifying the insole corresponding to said closest match.

3. A shoe selling apparatus according to claim 2, further comprising an insole vending unit for providing the identified insole corresponding to said closest match.

4. A shoe selling apparatus according to claim 2, wherein the communication module also transmits data relating to the identified insole corresponding to said closest match.

5. A shoe selling apparatus according to claim 1, wherein the communication module also transmits the digital data representation of said size parameters.

6. A system for purchasing shoes comprising:
(a) one or more shoe selling apparatuses according to claims 1;
(b) a system server for receiving particulars relating to purchasing individual and data relating to a selected shoe and for initiating a sequence of supply of purchasing shoes to the purchasing individual.

7. A system according to claim comprising a computer network addressable site.

8. A method for purchasing shoes comprising:
(a) determining the size parameters of the foot of an individual by an electronic pedometer and/or digital camera and image analysis software;
(b) obtaining digital data representation of said parameters;
(c) selecting a desired and matched shoe type and transmitting data representative of the selection of said selected shoe type and the particulars of the purchasing individual to a system server;
(d) selecting, on the basis of the details of the selected shoe and of said digital data representation of said parameters, an insole that matches both the customer's foot and the selected shoe, thereby to generate a close matching shoe for the analyzed foot; and
(e) dispatching to the individual the selected shoe.

9. A method according to claim 8, wherein the insole matching said foot parameters is provided by a method comprising (i) receiving the digital data representation of the foot parameters; (ii) comparing said data representation to a database containing a plurality of data items each of which relates to a foot type for which an insole is available, to identify an insole being a closest match to said data representation; and (ii) identifying the insole corresponding to said closest match.

10. A method according to claim 9, wherein the information of the identified insole is used to provide the individual with an insole at the shoe-selling apparatus site.

11. A method according to claim 9, wherein the insole is provided by an insole vending unit.

12. A method according to claim 9, wherein the information of the identified insole is communicated to the system server, and wherein the insole is dispatched to the individual together with the purchased shoe.

13. A method according to claim 12, wherein the insole is provided as an integral part of the shoe.
